(19) United States
(12) Patent Application Publication
(10) Pub. No.: US 2013/0035990 A1
(43) Pub. Date: Feb. 7, 2013

(54) Software solution for Visual Sales process simulation and management

(71) Applicant: Rajesh Sharma, Cupertino, CA (US)

(72) Inventor: Rajesh Sharma, Cupertino, CA (US)

(21) Appl. No.: 13/400,111

(22) Filed: Feb. 19, 2012

Related U.S. Application Data
(60) Provisional application No. 61/448,417, filed on Mar. 2, 2011.

(51) Int. Cl. G06Q 10/06

(52) U.S. Cl. 705/7.36; 705/7.38

(57) ABSTRACT

A method that allows sales management to build a predictable sales model is disclosed. The invention is a software solution that integrates corporate sales strategy with sales and pre-sales process allowing sales management to build a Predictable Sales Model for managing sales. With built-in features, analytics, intelligence and configurable templates the invention reduces implementation cost and time and provides a visual sales process simulation and management solution.

### RELATED APPLICATION DATA

This application claims the priority of prior U.S. provisional application Ser. No. 61/448,417 filed on Mar. 2, 2011, which is hereby incorporated by reference herein in its entirety.

### TECHNICAL FIELD

The invention is a Software solution that integrates Corporate Sales Strategy with Sales and Pre Sales process allowing Sales management to build a “Predictable Sales Model” for managing sales. With built-in features, analytics, intelligence and configurable templates the invention reduces implementation cost and time and provides a Visual Sales Process simulation and Management solution.

### BACKGROUND

Increasing Sales is always a priority of company executives as Sales performance quarter over quarter and year over year is considered as one of the top measures by investors among others for making investment decisions. For managing the sales process companies invest in sales systems, today the market provides many products for recording sales information however “Out of Box” customers have to invest high dollars for customization before the system becomes ready for use. This is because (1^{st}) current products lacks domain knowledge of the Sales Process, (2^{nd}) current products lack core features that increase productivity, (3^{rd}) customers incur additional investment for implementing sales analytics solutions such as dashboards and reports, (4^{th}) there are no tools within the system for Sales Engineer who perform Pre Sales activities like Collecting Customer Requirement, Managing Proof of Concept (POC) or Completing Request for Information (RFI).

The cost for implementing custom requirements in most cases exceeds product license cost and the final cost per user is much higher than the original product cost/user that influenced the decision. High cost and deployment time is among the top reasons for a failed implementation as identified by leading industry analysts (See Table 1), leaving company executives with no real way to measure Return on Investment.

TABLE 1
Failed Implementation

| 1. 2001 Gartner Group 50% | 2. 2005 AMR Research: 18% |
|---|---|
| 3. 2006 AMR Research: 31% | 4. 2007 AMR Research: 29% |
| 5. 2007 Economist Intelligence Unit: | 6. 2009 Forrester Research: 47% |
| 56% | |

Accordingly it may be desirable to provide a solution that reduces implementation cost and time and provides company executives with a real way to measure their Return on Investment. The invention is a Software solution that integrates Corporate Sales Strategy with Sales and Pre Sales process allowing Sales management to build a “Predictable Sales Model” for managing sales. With built-in features, analytics, intelligence and configurable templates the invention reduces implementation cost and time and provides a Visual Sales Process simulation and Management solution.

### SUMMARY

The objective of the invention is to reduce the implementation cost and time and provide “Out of box” solution for each of the areas mentioned in section 0003:
1. Domain Knowledge of Sales Process: The present invention provides domain knowledge templates that integrates corporate sales strategy with sales process such that the templates can be leveraged for creating a predictable sales model, the method comprises the steps of:
   A. Building Corporate Sales Strategy: Corporate executives are expected to provide growth solutions for revenue, margin, shareholder value this method integrates corporate sales strategy within the system and comprises the steps of:
      i. Reviewing and analyzing past sales performance levers such as Total Prospects, Team Size, Price, Discount, Revenue (these metrics are examples so the user is not limited to only these choices)
      ii. Based on the analysis a desired growth rate for example X % for the next year is determined
      iii. “What-If” analysis is then performed on 1 or more sales levers by increasing or decreasing their values until the desired revenue is achieved
      iv. Budget requirements for achieving the desired growth is calculated based on user input for Marketing, Travel or Increase in Team size (these costs are example so the user is not limited to these choices)
   B. Publishing Corporate Sales Strategy: Provides direction to Sales Management, aligns them with the corporate goals and visions, the method comprises the step of:
      i. Assigning revenue quota to the corporation as determined by the “What-If” analysis effort
      ii. Assigning revenue quota to 1 or more sales organization within the corporation, where the sum of revenue quota does not exceed corporation quota
      iii. Assigning revenue quota for each sales region within each sales organization, where the region revenue quota does not exceed sales organization revenue quota
      iv. Assigning revenue quota to 1 or more sales territory within the sales region, where the sum of sales territory revenue quota does not exceed region revenue quota
      v. Assigning revenue quota to 1 or more sales team within the sales territory, where the sum of sales team revenue quota does not exceed territory revenue quota
   C. Implementing Corporate Sales Strategy: Allows sales management to leverage configurable sales domain templates for implementing corporate sales strategy, the method comprises the step of:
      i. Implementing Revenue Strategy by configuring pricing model template for each delivery type such as online delivery (Software as Service “SaS”) with a monthly subscription price per user or On-premise delivery with a perpetual license price per user. Further targeted solution packages for specific industry or market segment can be created by leveraging solution package templates
      ii. Implementing Sales Strategy by configuring sales territory template for updating or creating new sales territories, configuring sales process, stage and step template for building a predictable sales model with assigned weightage for each sales stage and assigning best practice sales steps that must be performed within each sale stages to ensure successful completion of that stage
      iii. Implementing Account Strategy by assigning appropriate teams with roles, reporting structure and commission rate for managing deals within their sales territories
      iv. Implementing Customer Strategy by configuring templates that enhance customer loyalty by automating reminder process for renewing their subscription or license
2. Increase Productivity: The present invention provides infrastructure, features and automation that increases productivity during initial system implementation and thereafter on-going system usage, the method comprises the steps of:
   A. System Implementation Infrastructure: Speeds up system implementation process and makes it available faster for use, the method comprises the steps of:
      i. Providing an instruction-led framework for setting up organization hierarchy by defining a corporation, sales organization, sales region, sales territory, sales process, pricing, product, product features, solution packages, sales teams, reporting hierarchies, roles, assigned discount limits and commission rates on successfully closing sales deals
      ii. Providing integration framework for extracting data from files by providing pre-defined data integration adaptors formats and pre-defined migration adaptors for extracting data directly from competitive solution providers
   B. Increasing User Adoption: Provides features within the system that encourages Sales teams to use the system, the method comprises the steps of
      i. Providing motivation features where the system guides Sales teams to “Prioritize” their Prospects, Account and Deals that have the highest chances of meeting revenue targets and use a system generated “Visual Sales Path” that presents a road map for proactively planning sales actions by highlighting significant steps taken in the past within each sales stages, proactively aligning resources, planning pre sales efforts (RFI & POC) and understanding industry negotiation patterns so sales teams can appropriately price their deals to shorten negotiation time
      ii. Providing 1 Click features that either reduces or eliminates data entry for example 1 click Prospect Qualification feature automatically creates system of records for a potential account, its contacts, address, potential deal and appropriately updates the pipeline information
      iii. Pushing actionable information to users such as Notifications, Alerts and Reminders (these are examples so user is not limited to these choices) that further initiates automatic system update for reducing data entry efforts for example when a user marks a meeting reminder as “Complete” the system automatically updates the “To Do” list
      iv. Reducing navigation by providing minimal forms for completing the sales process, by pre-populating information wherever possible and by providing shorter forms that either reduces or eliminates any horizontal or vertical scrolling on the screen
   C. System Automation Increases sales team productivity by saving them time for performing administrative tasks, the method comprises the step of:
      i. Automatically preparing sales proposal when 1 or more customer requirements are recorded in the Requirements template and by providing information of additional packages that have been sold in the past for similar deals
      ii. Automatically preparing weekly time cards based on the user activities recorded in a calendar that also provides as a Time Management solution with time categories such as Meeting, Travel, Training, Product Demonstration for analyzing sales team work load, costly activities or bottlenecks (these are examples so the user is not limited to these choices)
      iii. Providing an intelligent search that increases information access velocity with features such as filtering, sorting and various analytical dimensions such as Industry, Organization, Year and Quarter (these are examples so user is not limited to these choices)
3. Sales Analytics Solution: The present invention provides multiple relational databases for storing master, transactional, historical and analytical data for measuring sales performance, the method comprises the steps of:
   A. Master Database Provides a relational storage for maintaining master data that is used for validation, lookup or system setup purposes, the method comprises the step of:
      i. Providing relational storage for industry standard information such as Country, State, City, Zip, Industry Types, Industry SIC codes, Year, Month, Day (these are examples)
      ii. Providing relational storage for recording setup information such as Corporation, Organization, Region, Territory, Products, Pricing, Process, User, Roles (these are examples)
   B. OLTP Database Provides a relational storage for recording transactional information at each of the sales process, the method comprises the step of:
      i. Providing relational storage for transaction information such as Prospect, Account, Contact, Address, Project, Requirements, Activities, Deal (these are examples)
      ii. Providing relational storage for pulling and pushing actionable information such as Notifications, Alerts, Reminders, Approvals (these are examples)
   C. History Database Provides a relational storage for recording any changes made to the Master and (OLTP) databases, the method comprises the step of:
      i. Recording Slowly Changing Dimension (SCD) by maintaining date-time stamp along with a flag within the History database for each record that is either updated, deleted or new
      ii. The date-time stamp indicates the date when a record was changed, while the flag indicates the record is most recent
   D. OLAP Database Provides a relational storage for recording business facts and hierarchies (Dimension), the method comprises the step of:
      i. Providing relational storage for 30+ business facts using which performance metrics such as Revenue, Total Prospects, Prospect Quality, Accounts, Stuck Accounts, Total Deals, Discount, Top 10 Accounts, Top 5 Sales Teams can be derived (these are examples)
      ii. Providing a relational storage for 5+ Dimensions such as Time, Geography, Deal, Sales Process (these are examples). Business facts when used in combination with dimensions provides 150+ key performance indicators (KPI) for measuring sales performance
   E. Database Synchronizing Program Provides integration between Master, OLTP, History and OLAP databases, the method comprises the step of:
      i. Providing automated integration software program for synchronizing any changes in Master and OLTP database with History database, where the frequency for synchronizing the databases is configurable
      ii. Providing automated integration software program for synchronizing History database with OLAP database for ensuring the most recent is information is available at all times, the frequency for synchronizing the databases is configurable
   F. Analytical Components Enhances speed for interpreting information and making decisions, the method comprises the step of:
      i. Providing analytical components such as Data Grids for listing information, Charts—Bar, Line, Column, Pie, Bubble for time series, distribution and scatter type analysis
      ii. Providing analytical components such as Organization chart, Geographic map, sliders, counters, radial navigation for interacting and visualization of information
   G. Decision Perspectives Categorizes information into perspectives that provides visibility into various aspects of sales, the method comprises the step of:
      i. Displaying Revenue related information within the Revenue perspective by using 1 or more analytical components for presenting Revenue Intelligence across various dimension such as Time, Geography
      ii. Displaying Sales related information within the Sales perspective by using 1 or more analytical components for presenting Sales Intelligence across various dimension such as Time, Geography
      iii. Displaying Account related information within the Account perspective by using 1 or more analytical components for presenting Account Intelligence across various dimension such as Time, Geography
      iv. Displaying Customer related information within the Customer perspective by using 1 or more analytical components for presenting Customer Intelligence across various dimension such as Time, Geography
4. Pre Sales Tools: The present invention provides Discovery, Demo and Requirements Templates that accurately collects requirements from an initial stage to build an overall customer requirement along the Pre-Sales stages of the sales process, the method comprises the steps of:
   A. Discovery Template That provides a listing of salient features for determining a prospective fit during the initial stage of the sales process, the method comprises the steps of:
      i. Providing a list of salient features for all product categories along with business benefits so that accuracy and consistency for communicating and collecting prospect requirement is maintained
      ii. Ability to add more features in addition to the salient features listed in the Discovery Template
      iii. Marking 1 or more features as “Required” item during the Solution demonstration stage
   B. Demo Template Identifies products and features that must be demonstrated to the prospect during a scheduled meeting, the method comprises the steps of:
      i. Listing all available feature collected using the Discovery Template that must be demonstrated during a scheduled meeting
      ii. Ability to add more features beyond as a part of the overall requirement from a desired solution
   C. Requirements Template Identifies technical qualification criteria for influencing a purchase decision, the method comprises the steps of:
      i. Ability to record requirements for custom development
      ii. Identifying and Marking 1 or more products that supports the features collected in the Discovery and Demo Template
      iii. Marking 1 or more features as success criteria for influencing a purchase decision following a technical qualification effort during the Proof of Concept (POC) stage of the sales process

### BRIEF DESCRIPTION OF THE DRAWINGS/FIGURES

FIG. 1 is a block diagram illustrating a method according to an embodiment of the present invention (Visualization).

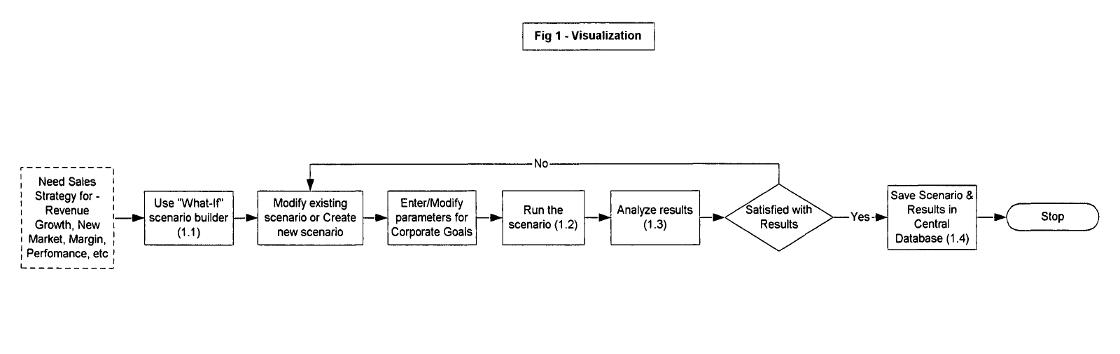

FIG. 2 is a block diagram illustrating a method according to an embodiment of the present invention (Sales Strategy).

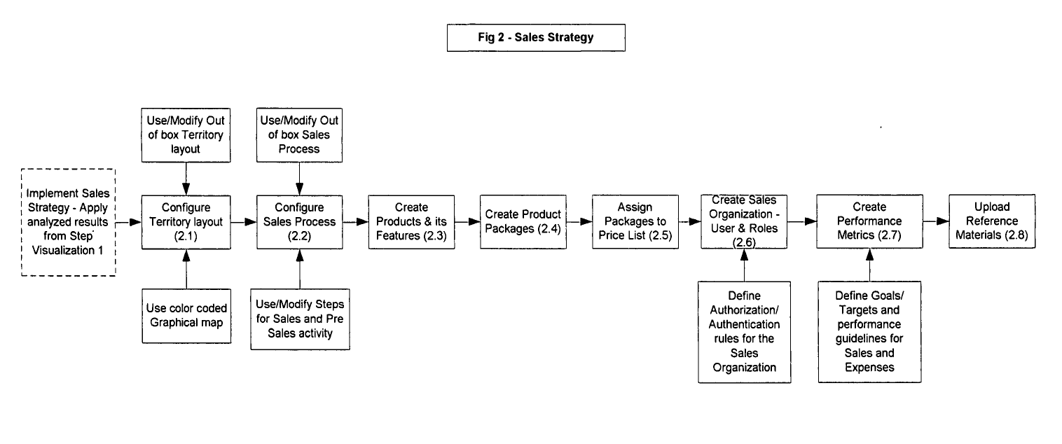

FIG. 3 is a block diagram illustrating a method according to an embodiment of the present invention (Intelligence).

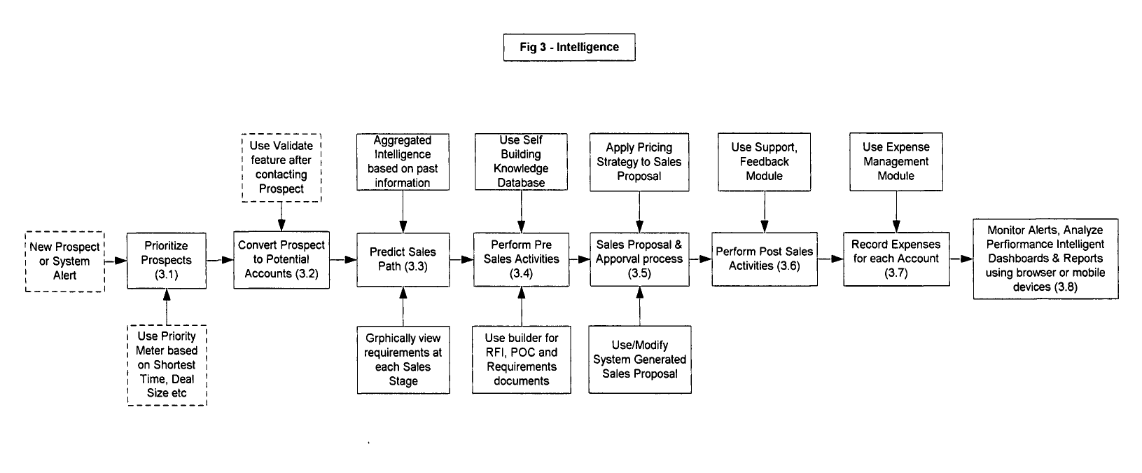

### DETAILED DESCRIPTION

Method 1 describes the method for visualizing a sales strategy based on the input from the user. In this step of Visualization 1, the power user (such as Vice President Sales, C—level Executives or Sales Manager) of the present method uses “What-If” scenario builder (1.1) with various business and sales levers for building a Sales Strategy. Business and Sales levers are metrics that correspond to the corporate goal and vision such as percentage of revenue growth, margin, expense reduction or price increase. Step Run the Scenario (1.2) allows the power user to “Try & Test” the Sales Strategy prior to an actual strategy implementation. The step Analyze Results (1.3) provides sales management with visibility into the inter relationship between each business and sales lever. The system provides flexibility to create, test and run the scenario using different levers until the sales management is satisfied with the result. The final Strategy is saved in a central database within the system (1.4). Net outcome of the scenario building effort is that area of variations within the sales process is amplified and that helps the sales organization to develop a Predictable Sales Path at various stages of the sales cycle. Use of graphical tools increases the analytical ability to make quick decision and conduct meaningful strategic discussions.

Method 2 describes the method for implementing a sales strategy based on the outcome of Step Visualization 1. In this step Sales Strategy 2 the power user (mostly Sales Manager or Vice President Sales) uses/modifies “Out of box” templates to implement a Sales Strategy for Territory, Process, Price List, Product/Package, Revenue Goals and authorization for the entire Sales organization. This aligns the entire sales organization with the corporate goal and vision determined in Step Visualization 1. Using the built-in territory (2.1) and sales process (2.2) template the power user configures the “Out-of-box” territory layout that is presented in a graphical format. Next the power user configures the “Out-of-box” sales process (2.2) that has assigned weight age for typical Sales Stages and its Next Steps that are considered as best practice for those Sales Stages. The weight age, sales stages and its associated next steps are completely configurable to suit the customer's sales process. Within this step Sales Strategy 2, the power user defines various product lines (2.3) along with features and marketing messages that describe its benefits. One or more products can be combined to create a Package (2.4) that allows the sales organization to offer choice of product mix to their customers. Price List (2.5) lists each package with a Price tag; 1 or more Price Lists corresponding to each revenue channel such as OEM, Online Sales, Channel Partner or Resellers can be created. Next the power user defines the User (2.6), their role, organization and associates each user to a territory. Each user is assigned a quota along with performance measurement guidelines (2.7) for sales and expenses. The quota is then grouped at territory level for each sales organization such as OEM, Online sales etc.

Method 3 describes the method for executing a sales strategy based on step Visualization 1 and Sales Strategy 2. In this step Intelligence 3 the Account Executive, Sales Manager and Sales Engineer execute the sales strategy at various stages of the sales cycle and C-level Executives and Sales Management analyze performance of the Executed Strategy using “Out of box” decision oriented dashboards. Step Intelligence 3 is initiated when Account Executive is automatically assigned New Prospects following an upload process, manual entry, online inquiry or from a mobile device. The Account Executive uses a prioritization feature (3.1) that prioritizes the Prospect list based on for example shortest time, average deal size or average sales cycle time (these metrics are examples so the user is not limited to only these three choices). Following a manual contact the Account Executive uses a Validate feature that converts 1 or more qualified Prospect to Potential Account (3.2); further the Account Executive can leverage the Predictable Sales Path feature (3.3) that presents summary and detailed information about actions taken in the past for similar type of sales (for example factors analyzed are—Industry, Prospect size, RFI, POC etc) at each sales stage. This allows the Sales Executive and Sales Engineer to plan, prepare and build domain expertise for Pre Sales activities (3.4) such as Request for Information (RFI), Proof of Concept (POC) or understand industry requirements. Once the Sales Engineer collects the customer requirements the system automatically identifies relevant products and builds a suggested Sales Proposal (3.5) by applying the right Price List. Built-in workflow automatically routes any sales proposal that require manager approval.

The present invention also provides capability for performing Post Sales activities (3.6) such as Customer Support and also conducting feedback survey with customers. The ability to view customer support cases and analyze responses from feedback survey within an integrated sales management system provides complete view of the customer allowing the sales organization to provide prompt and efficient service. Further the system also provides an Expense recording module (3.7) that records expense incurred at each stage of the sales cycle for each account. With decision-oriented dashboards (3.7) the entire sales organization can analyze performance of the sales strategy in terms of margin, revenue per sales executive, average industry expense, industry revenue etc (the metrics required for measurement is completely configurable).

Relationship Between the Steps or Elements (Flow and Logic):

The preferred relationship between the three major steps is shown as Visualization 1, Sales Strategy 2 and Intelligence 3. The order between Visualization 1 and Sales Strategy 2 may be changed or the Step Visualization 1 may be omitted, however the Step Intelligence 3 must occur after the Step Sales Strategy 2 because Sales Strategy 2 provides authentication and authorization for the entire sales organization to access the system. The preference of using Visualization 1 prior to Sales Strategy 2 is to leverage the analyzed results for example Percentage Price Increase, Total Prospect, Percent Revenue growth etc and apply at various stages within the Step Sales Strategy 2. In cases where the Step Visualization 1 is omitted, these values may be derived/analyzed outside of the system and entered manually using Step Sales Strategy 2.

In the Step of Visualization 1, although it is shown that a business need for revenue growth, price increase etc initiates the effort for developing a strategy, a power user at any time can proactively create as many “What-If” scenarios within the system and apply its analyzed results when the business needs.

In the Step of Sales Strategy 2, although it is shown that the Step Sales Strategy 2 is initiated to incorporate the analyzed results from Step Visualization 1, it is not necessary that the results must be entered prior to any activity. A navigation preference is shown as an example; however the order can be completely changed such that Upload Reference Material (2.8) may be performed prior to Configure Territory Layout (2.1), and so forth.

In the Step of Intelligence 3, the preference to execute the sales strategy is shown when the process is initiated by automatic assignment of prospects. However any user within the sales organization can directly begin this step by analyzing alerts, performance (3.8) or record expense (3.7), and so forth before working with the newly assigned prospects. Further the activities with the Step Intelligence 3 can be completely changed by defining a desired process flow (2.2) within the Step of Sales Strategy 2.

How the Invention Works:

The method works as follows. C-level executives are expected to provide growth solutions for revenue, margin, shareholder value or new market, when Sales Management is communicated about the corporate goals the need to develop a Sales Strategy becomes imperative. For developing a strategy sales management can use various business and sales levers that correspond to the corporate goals and vision. Examples of business levers are but not limited to Percentage revenue or margin increase or selecting new market. Examples of sales lever are but not limited to price increase or decrease or increase margin or number of Account Executive. One or more scenario is created using various business and sales levers for developing a strategy in the Step of Visualization 1 and after “Trying and Testing” the scenario the most suitable strategy that maps to the corporate goal and vision is implemented.

Implementation of the strategy (Step Sales Strategy 2) happens when analyzed results from Step Visualization 1 or results derived outside of the system is applied to each territory, process, price list, product/package, expense etc. The implemented strategy is available to the entire sales organization, which ensures they are aligned with the corporate objectives and are working towards a common goal as defined by the sales strategy. The strategy is executed (Step Intelligence 3) when the sales process is initiated following an automatic assignment of prospects; thereafter the sales process (2.2) defined within the Step Sales Strategy 2 is applied to each potential account (3.2). Further the productivity for serving a prospect or potential account is enhanced by using built-in tools such as Prioritization, Prediction of Sales path, Pre Sales activities (RFI, POC) and automatic generation of other documents such as Sales proposal and weekly time cards. Performance of various territory, product, industry and sales team is monitored by analyzing information presented in analytical decision oriented dashboards/reports that allow C-level executives and sales management to determine the effectiveness of the current strategy and make intelligent adjustments without losing focus of the corporate goals.

Since the strategy is executed for each potential account the sales process for that account logically ends when Account Executive receives intimation from the potential account that the sales proposal is either accepted or denied. However selling is an iterative business process, so steps for executing, monitoring and analyzing performance of the executed strategy never stops.

Necessary and Optional Elements of the Invention:

The step of Visualization 1 may be omitted if the user has derived/analyzed values related to the corporate vision and goals outside of the system. In cases where the values are derived/analyzed outside the system they can be manually entered using Step Sales Strategy 2.

Within the Step of Sales Strategy 2 the activity Create Sales Organization—User & Roles (2.6) must be performed as it authenticates/authorizes and provides access to the entire sales organization to use the system for performing Step Intelligence 3. All other activity within the Step Sales Strategy 2, such as Upload Reference Material (2.8), Create Products and Packages (2.4) etc may be postponed or performed in any order, however activities such as Territory layout (2.1), Sales Process (2.2), Products & Features (2.3), Packages (2.4) and Price List (2.5) must be performed prior to Step Intelligence 3 in order to apply guidelines and rules for the corporate goal and vision.

Within the Step Intelligence 3, the activity to validate prospect (3.2) must be performed to create potential account. All other activities within the Step Intelligence 3 is optional, however to identify bottlenecks or success factors at each stage of the sales cycle the Step Intelligence 3 provides a recommend flow.

Machines, Computers or Systems that can perform the Function of the Invention:

The invention is a software solution that works in combination with user input and built-in workflow automation. The invention requires either a standalone computer with information output device (such as monitor or mobile electronic device), an information input device (such as keyboard, mouse, mobile electronic device, touch screen or microphone) or a central computer server with a web browser and Internet access. Architecture may be implemented in a multi-tier or a single-tier or a client-server model.

On a standalone system a user would not require Internet access and will be able to access the system using a browser. An Internet access is required only when the user wants to send information outside of the system by using email. When the invention is installed on a central computer server, users (entire sales organization) will need either a mobile electronic device with browser and Internet access or a laptop computer with browser and Internet access. Implementations of the various techniques described herein may be implemented in computer hardware, firmware, software, or in combination of them. Implementation may be deployed as a software application running on a computer or mobile devices such as PDA, cell phone, etc. The software application as the computer program described above, can be written in any form of programming language, including compiled or interpreted language, and can be deployed in any form, including as a stand-alone program, module, component, subroutine, or other unit suitable for use in a computing environment. A computer program can be deployed to be executed on one computer or on multiple computers at one site or distributed across multiple sites and interconnected by a communication network. The solution can be offered as stand-alone packaged software, as a SaaS offering (Software-as-a-service) or even in a cloud-computing environment. This invention is independent of all these computing environments and thus covers all deployment environments, which are infrastructure aspects and not the capabilities envisioned in the concept.

To provide for interaction with a user, we have chosen a specific User Interface (UI) technology. It is possible to use any UI technology to render this application. The UI may be implemented on a monitor, for displaying information to the user. Other kinds of devices can be used to provide for interaction with a user as well; for example, feedback provided to the user can be any form of touch (Apple iPhone), voice activated or any other machine readable input from the user can be received.

How to Use the Invention:

The previous section of the steps and their relationship described how users (entire sales organization) would use the invention.

Can it be Used in a Different Way?

Within the scope of sales process simulation and management the invention can be used by wide range of businesses that can configure the “Out of box” process to suit their custom needs. Further businesses in private equity market can also use this invention for measuring the performance of their investment portfolio. A software console can be built to pull agreed information from each investment base where the invention is installed allowing them to measure performance of their investment portfolio.

While certain features and scenarios of the described implementations have been illustrated as described herein, many modifications, substitutions, changes, refinements and equivalents are possible based on this initial design. Hence, it is understood that the claims stated herein are intended to cover all such enhancement, modifications and changes that will fall within the various instantiations of this invention.

A System that could Benefit from the Invention:

Businesses of various sizes and all users of their entire sales organization will benefit from this invention that is built on a structured approach of Visualization, Sales Strategy and Intelligence. Further within each step of Visualization, Sales Strategy and Intelligence built-in functionality, tools and features combine to offer a “Sales Ready” and “Decision Ready” solution.

For evolving companies with limited resources a “Sales Ready” allows them to adopt a structured and strategic approach in their early stages, while a “Decision Ready” solution reduces or eliminates the burden for expensive product customization budget. Growing and Mature companies will experience similar benefit, as their efforts for expensive product customization will scale down to configuration. All business sizes will be able to implement their projects faster with a “Sales Ready” and “Decision Ready” solution.

Products, Devices and Useful Items Produced by the Invention:

Out of box this method produces reports and decision oriented analytical dashboards; further it provides templates for generating time cards, sales proposal, Request for Information (RFI), Requirements document, Proof of Concept (POC), Expense report and number of informational and analytical reports in print and download format.

What is claimed is:

1. A method that allows sales management to build a Predictable Sales Model, the method comprising the steps of: building corporate sales strategy, publishing corporate sales strategy and implementing corporate sales strategy.

2. The method of claim 1, wherein the step building corporate sales strategy comprises of steps: reviewing and analyzing past sales performance, determining desired future growth rate, performing “What-if” scenarios, determining budget requirements for achieving the desired growth.

3. The method of claim 1, wherein the step of publishing corporate sales strategy comprises of steps of: assigning revenue quota within the corporation hierarchy, sales organizations, region, territory and sales team.

4. The method of claim 1, wherein the step of implementing corporate sales strategy comprises of steps: map corporate sales strategy for implementing a Revenue strategy, Sales strategy, Account strategy and Customer strategy.

5. A method that allows sales organization to increase Productivity, the method comprising the steps of: providing an infrastructure for faster system implementation, features for increasing user adoption and system automation for reducing administrative time.

6. The method of claim 5, wherein the step of providing an infrastructure for faster system implementation comprises the steps of: providing instruction-led framework for setting up the organization hierarchy and providing integration adaptors for extracting data from multiple sources.

7. The method of claim 5, wherein the step of providing features for increasing user adoption comprises the steps of providing motivation features, 1 Click features, pushing actionable information and reducing navigation forms for completing any step or process.

8. The method of claim 5, wherein the step of system automation comprises the step of: reducing administrative tasks for preparing sales proposal, weekly timecards and providing intelligent search that increases information access velocity.

9. A method that allows sales organization to perform Sales Performance analytics, the method comprising the steps of: providing a master database, online transaction processing (OLTP) database, History database for maintaining historical information, online analytical processing (OLAP) database, database synchronizing program, analytical components for making quick decisions and information perspectives for relating the decisions with business functions or facts.

10. The method of claim 9, wherein the set of providing a master database comprises the step of: providing a relational storage that allows customers to maintain and manage their master data that is required in various forms for validation and lookup purposes.

11. The method of claim 9, wherein the step of providing an online transaction processing (OLTP) database comprises the step of: providing a relational storage for recording transaction and actionable information occurring at each stage of the sales process.

12. The method of claim 9, wherein the step of providing database for maintaining historical (History) information that records any changes made to Master and (OLTP) database, comprises the step of: recording Slowly Changing Dimension (SCD) that provides the foundation for performing sales analytics over time.

13. The method of claim 9, wherein the step of providing an online analytical processing (OLAP) database comprises the step of: providing relational storage for recording business facts (Facts) and hierarchies (Dimension) that form the building blocks required for measuring sales performance.

14. The method of claim 9, wherein the step of synchronizing databases comprises the step of providing automated integration between Master, OLTP, History and OLAP.

15. The method of claim 9, wherein the step of providing analytical components comprises the step of: providing appropriate and relevant visual components that enhances speed for interpreting information.

16. The method of claim 9, wherein the step of providing information perspective comprises the step of: categorizing information into perspectives such as Revenue, Sales and Account (but not limited to these examples) for providing visibility into various aspects of sales.

17. A method that increase Pre Sales scalability, the method comprising the steps of: providing pre sales templates for increasing speed and maintaining consistency of pre sales efforts.

18. The method of claim 17, wherein the step of providing pre sales templates comprises the step of: providing templates for discovering solution needs, product demo requirements, features requirement for determining technical qualification criteria.
